(19) United States
(12) Patent Application Publication
(10) Pub. No.: US 2018/0090054 A1
(43) Pub. Date: Mar. 29, 2018

(54) Tiled Display System and Control Method Thereof

(71) Applicant: BOE Technology Group Co., Ltd., Beijing (CN)

(72) Inventor: Zhiguo Zhang, Beijing (CN)

(73) Assignee: BOE Technology Group Co., Ltd., Beijing (CN)

(21) Appl. No.: 15/538,027

(22) PCT Filed: Nov. 11, 2016
(86) PCT No.: PCT/CN2016/105492

§ 371 Date: Jun. 20, 2017

(30) Foreign Application Priority Data
Mar. 28, 2016 (CN) 201610189280.4

(51) Int. Cl. G09G 3/20; G06F 3/14

(52) U.S. Cl. CPC G09G 3/2096; G06F 3/1446; G09G 2370/16; G09G 2356/00; G09G 2300/026; G09G 2340/14; G09G 2370/12

(57) ABSTRACT

A tiled display system and a method for controlling the tiled display system are disclosed. The tiled display system includes a combiner and a plurality of tile screens. A plurality of transmission channels of the combiner are connected one-to-one to the plurality of tile screens. The method for controlling includes the combiner communicates with each of the tile screens respectively, and determines the position of each tile screen according to the strength of the signal received from each tile screen; the combiner controls the plurality of transmission channels to transmit respectively a plurality of sub-display signals obtained by dividing the complete display signal to be tile-displayed on the plurality of tile screens, so that the plurality of tile screens can be tiled to display the complete display signal.

### TECHNICAL FIELD

The present disclosure relates to a display field, especially a tiled display system and a method for controlling the tiled display system.

### BACKGROUND

With the progressive development of display technology, the demand for large-scale display panels is increasing, however, the current large-scale display panel yield is low and its cost is high. In such a situation, the tiled display system comes into being. The so-called tiled display system means that a plurality of screens with small area (tile screens) are tiled to form one single block large-screen, at the same time, the complete display signal to be displayed is divided into a plurality of sub-image signals having the same number as that of the tile screens of small area, and then the plurality of sub-image signals are transmitted to respective tile screens with small area respectively to display. With the tiled display system, it is possible to achieve a large screen display, and to reduce the hardware cost with respect to the large-scale display panel. However, in the existing tiled display system, it is necessary to manually perform a relatively troublesome tiled setting before the tiled display. Particularly, when the number of the tile screens is large, in particular, when the number of the transmission channels that can be used to transmit the sub-image signal does not correspond to the number of the tile screens, it is always difficult to determine the corresponding connection relationship between each of the transmission channels and each of the tile screens. Therefore, it is common practice for the present to connect each of the transmission channels that transmits the sub-image signal to each of the tile screens respectively in any correspondence, then after the completion of the hardware connection, a connection test is performed by professionals at the PC or cellphone (tablet PC) ends so as to determine the proper corresponding connection relationship between each of the transmission channels and each of the tile screens, then a hardware connection is performed once again by the staffs according to such a proper corresponding connection relationship. The above tiled setting process requires a relatively complicated manual operation, a great workload, and the operation carried out by professionals, resulting in lower efficiency of the tiled setting and increased labor costs.

### SUMMARY

The present disclosure has been set forth in view of the above problems.

According to one aspect of the present disclosure, a method for controlling a tiled display system is provided. The tiled display system includes a combiner and a plurality of tile screens. A plurality of transmission channels of the combiner are connected one-to-one to the plurality of tile screens. The method for controlling comprises that the combiner communicates with each of the tile screens respectively, and determines the position of each of the tile screens according to a strength of the signal received from each of the tile screens; the combiner controls the plurality of transmission channels to transmit respectively a plurality of sub-display signals obtained by dividing a complete display signal to be tile-displayed on the plurality of tile screens; for each of the transmission channels, the combiner determines which tile screen the transmission channel is to be connected to, according to a feedback signal sent by the tile screen which has received the sub-display signal transmitted by the transmission channel; the combiner regulates the sub-display signal transmitted in each of the transmission channels according to the tile screens connected with the transmission channels respectively and the position of each of the tile screens, so that the plurality of tile screens can be tiled to display the complete display signal.

According to another aspect of the present disclosure, a tiled display system is provided. The system comprises a plurality of tile screens to be tiled to display a complete display signal and a combiner; the plurality of transmission channels of the combiner are connected one-to-one to the plurality of tile screens, the combiner is configured to determine the sub-display signals to be transmitted by the plurality of transmission channels respectively, so that the plurality of tile screen can be tiled to display a complete display signal, and the sub-display signals are obtained by dividing the complete display signal. The combiner and each of the tile screens are equipped with wireless communication modules respectively, the combiner determines the sub-display signals to be transmitted by the plurality of transmission channels respectively as follows: communicating with each of the tile screens via a respective wireless communication module, and determining a position of each of the tile screens according to a strength of the signal received from each of the tile screens; controlling the plurality of transmission channels to transmit the plurality of sub-display signals respectively; for each of the transmission channels, determining which tile screen the transmission channel is to be connected to, according to a feedback signal sent by the tile screen which has received the sub-display signal transmitted by the transmission channel; and determining the sub-display signals transmitted by the plurality of transmission channels respectively according to the tile screens connected by the transmission channels respectively and the position of each of the tile screens.

With the tiled display system and its control method according to the embodiments of the present disclosure, the combiner determines the position of each of the tile screens by communicating with the tile screens, and thus regulates the sub-display signal transmitted in each of the transmission channels so that plurality of tile screens can be tiled to display the complete display signal. Hence the tiled setting is conducted automatically without requiring operation of the professionals, and there is also no need to reconnect the transmission channels and the tile screens in order to display the complete display signal, thereby improving the efficiency of tile screen setting and reducing manual workload.

### BRIEF DESCRIPTION OF THE DRAWINGS

Above and other purposes, features and advantages of the disclosure will be more obvious by describing embodiments of the disclosure in more details along with accompanying drawings. The drawings provide further understand of embodiments of the disclosure, constitute a portion of the specification, explain the disclosure together with embodiments of the disclosure and do not limit the disclosure. In the drawings, like reference numerals refer to like parts or steps.

FIG. 1 shows an exemplary schematic view of a tiled display system according to an embodiment of the present disclosure.

FIG. 2 shows a flow chart of a method for controlling the tiled display system according to an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Usually, the number of tile screens that can be tiled to form one single block large-screen can be 4, 6, 9, 12, 16 and the like, but this is not necessary, and according to particular application requirements, any number of the plurality of tile screens can be selected to be tiled to form a large-screen. Hereinafter, the present disclosure is described by way of a large-screen formed by tiled 4 tile screens for ease of explanation and description, but the present disclosure is similarly applicable for other number of a plurality of tile screens.

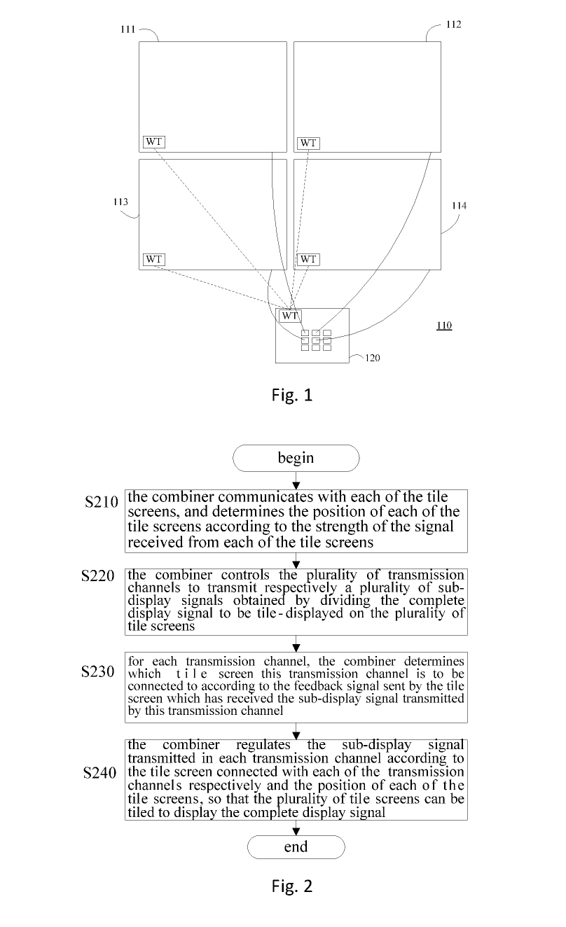

FIG. 1 shows an exemplary schematic view of a tiled display system 100 according to an embodiment of the present disclosure. As shown in FIG. 1, the tiled display system 100 comprises: four tile screens 111-114 for being tiled to display a complete display signal; a combiner 120 having four transmission channels C1-C4 connected one-to-one to the four tile screens 111-114. The combiner 120 is configured to determine the sub-display signal transmitted respectively by the plurality of transmission channels, so that the plurality of tile screens can be tiled to display the complete display signal (image). The sub-display signals are obtained by dividing the complete display signal. The combiner 120 and each of the tile screens 111-114 are equipped with wireless communication modules WT respectively. It should be noted that, although the combiner 120 in FIG. 1 is shown to have four transmission channels C1-C4, this is only an exemplary example, the number of the transmission channels of the combiner 120 may be more than four, and in such a case, any four transmission channels of the transmission channels of the combiner are connected one-to-one to the four tile screens.

As shown in FIG. 1, the tile screens 111-114 are arranged in the form of 2x2 so as to be tiled into one single block large-screen; four transmission channels C1-C4 corresponding to the number of the tile screens are connected one-to-one to the four tile screens 111-114. It should be appreciated that, ideally, the transmission channels C1-C4 sequentially transmit sub-display signals corresponding to the contents of the upper left portion, the upper right portion, the lower left portion and the lower right portion of the display signal respectively, and are connected to the tile screens 111-114 respectively, so that the tile screens 111-114 can correctly display the complete image signal. However, as mentioned above, before tiled to display, when a plurality of tile screens exist, in particular when the number of the transmission channels available for transmitting the sub-image signals does not correspond to the number of the tile screens (for example, the number of the transmission channels is greater than that of the tile screens), it is often difficult to easily determine the proper corresponding connection relationship between each of the transmission channels and each of the tile screens. Hence, the transmission channels C1-C4 are not required to be properly connected to the tile screens 111-114, but are connected one-to-one to the tile screens 111-114 respectively in any correspondence.

In the following, a detailed description will be made to the functional implementation of the combiner 120 by reference to FIG. 1. Particularly, the combiner 120 communicates with the respective wireless communication module WT of the tile screens 111-114 through its wireless communication module WT, respectively, and determines the position of each of the tile screens according to the strength of the signal received from the tile screens 111-114 respectively.

When performing the wireless communication, the wireless communication module of the combiner 120 may detect the strength of the signal received from the wireless communication modules of the tile screens 111-114, that is, the radio signal strength RSSI (Radio Signal Strength Indicator). And, when the transmitting power of the signal is known, the receiving end may calculate the propagation loss through the received power, and then the propagation loss can be converted to a distance by a theoretical or empirical propagation model. For example, in the free space, the strength of the signal received at the receiving end at a distance d from the transmitting end can be calculated by the following equation (1):

[Pr(d)]_{dBm}=[Pr(d₀)]_{dBm}−10n lg(d/d₀)+X_{dBm} (1)

where d is the distance (m) between the receiving end and the transmitting end; d₀ is a reference distance (m), generally 1 m; Pr(d) is the received signal power (dBm); Pr(d₀) is the received signal power (dBm) corresponding to the reference distance d0; X_{dBm} is a Gaussian random variable (dBm) with an average of 0, which reflects the variation of the received signal power when the distance is constant; n is the path loss index, which is an environment-related value, several typical values for n are shown below in table 1.

TABLE 1

| Environment | | n |
|---|---|---|
| Outdoor | free space | 2 |
| | Shaded urban space | 2.7~5 |
| Indoor | Viewing distance | 1.6~1.8 |
| | Space with blocking obstacles | 4~6 |

Therefore, the combiner 120 can measure the strength of the signal received from each of the tile screens 111-114 by its wireless communication module, then with the above equation (1), for example, it is possible to calculate the distance between each of the tiled screens 111-114 and the combiner 120. The wireless communication module may be various wireless communication modules such as Wi-Fi, Bluetooth, NFC, infrared, and the like.

Once the distance between each of the tile screens 111-114 and the combiner 120 is obtained, the combiner 120 can thereby determine the position of each of the tile screens 111-114. For example, for the arrangement of the tile screens and the combiner as shown in FIG. 1, it can be seen that the combiner 120 is the farthest from the upper left tile screen, the second farthest from the upper right tile screen, the third farthest from the lower left tile screen, and is closest to the lower right tile screen. Therefore, on the assumption that the combiner 120 calculates as above that the tile screen 111 is farthest therefrom, the tile screen 112 is the second farthest therefrom, the tile screen 113 is the third farthest therefrom, and the tile screen 114 is closest thereto, then the combiner 120 may determine that the tile screen 111 is located on the upper left, the tile screen 112 is located on the upper right, the tile screen 113 is located on the lower left, and the tile screen 114 is located on the lower right, that is, it is possible to determine the position of each of the tile screens 111-114. FIG. 1 shows only an exemplary arrangement manner, and does not limit the present disclosure. For other arrangement manner of the tile screen and the combiner, it is also possible to determine the position of each of the tile screens according to the distance between the combiner and each of the tile screens. It would be appreciated that, in order to accurately locate the position of each of the tile screens, the combiner should be avoid from being placed at a position at equals distances from the plurality of tile screens when arranging the combiner.

On the other hand, the controller 120 controls its four transmission channels C1-C4 to transmit the four sub-display signals obtained by dividing the complete display signal, respectively. Herein, for convenience of explanation, it is assumed that the transmission channels C1-C4 transmit sub-signals corresponding to the upper left portion, the upper right portion, the lower left portion and the lower right portion of the complete display signal, respectively. Subsequently, for each of the transmission channels, the controller 120 determines which tile screen the transmission channel is connected to according to the feedback signal sent back by the tile screen, which has received the sub-display signal transmitted by this transmission channel, through its wireless communication module. The transmission channels C1-C4 may be transmission channels such as HDMI, DVI, VGA and the like.

After determining the tile screen to which each of the transmission channels is connected to respectively and the position of each of the tile screens, as described above, the controller 120 may hereby regulate the sub-display signal transmitted in each of the transmission channels so that the plurality of tile screens can be tiled to display the complete display signal. Specifically, after determining the tile screen which each of the transmission channels is connected to respectively and the position of each of the tile screens, the controller 120 may determine the proper correspondence of each of the transmission channels to each of the tile screens, by which the plurality of tile screens can be tiled to display the complete display signal. For example, assuming the detection result is that the transmission channel C1 is connected to the lower right tile screen 114, the transmission channel C4 is connected to the upper left tile screen 111, the transmission channel s C2 and C3 are connected to the upper right and lower left tile screens 112 and 113 respectively, then the controller 120 may determine that the transmission channels C1 and C4 should exchange their connection, that is, the transmission channels C1-C4 should correspond sequentially to the upper left, upper right, lower left and lower right tile screens, respectively. In response to this determination, each of the transmission channels and each of the tile screens can be reconnected according to the determined correspondence. In this embodiment, it is not to carry out reconnection, but to regulate the sub-display signal transmitted in each of the transmission channels so that, for each tile screen, a sub-display signal is transmitted in the transmission channel connected with this tile screen which is determined according to the proper correspondence and transmitted in the transmission channel corresponding to this tile screen. For example, for the above situation, the transmission channel C1 connected to the lower right tile screen 114 is regulated to transmit the sub-display signal originally transmitted in the transmission channel C4, the transmission channel C4 connected to the upper left tile screen 111 is regulated to transmit the sub-display signal originally transmitted in the transmission channel C1, while the transmission channels C2 and C3 transmit the sub-display signals that they originally transmit. In this way, each of the tile screens receives a corresponding sub-display signal so that the complete display signal can tiled to display.

The tiled display system according to the embodiment of the present disclosure has bee described above. In this embodiment, the combiner in such a system determines the position of each of the tile screens by communicating with the wireless communication module of the tile screens via its wireless communication module, and hereby regulates the sub-display signal transmitted in each of the transmission channels so that plurality of tile screens can be tiled to display the complete display signal, hence the tiled setting is completed automatically without requiring operation of the professionals, and there is also no need to reconnect the transmission channels and the tile screens in order to display the complete display signal, thereby improving the efficiency of tile screen setting and reducing manual workload.

FIG. 2 shows a flow chart of the method for controlling the tiled display system according to an embodiment of the present disclosure, the tiled display system comprises a combiner and a plurality of tile screens, and the plurality of transmission channels of the combiner are connected one-to-one to the plurality of tile screens. For the convenience of description, by way of the tiled display system as shown in FIG. 1, a description is made in the following to the method for controlling the tiled display system according to the embodiment of the present disclosure with reference to FIGS. 1 and 2.

As shown in FIG. 2, in step 210, the combiner communicates with each of the tile screens, and determines the position of each of the tile screens according to the strength of the signal received from each of the tile screens.

In this step, the combiner 120 communicates with the respective wireless communication module WT of the tile screens 111-114 through its wireless communication module WT, and determines the distance between each of the tile screens 111-114 and the combiner 120 according to the strength of the signal received from the tile screens 111-114 respectively, through theoretical or empirical propagation model, and then determines the position of each of the tile screens 111-114. The wireless communication module may be various wireless communication modules such as Wi-Fi, Bluetooth, NFC, infrared, and the like.

In step 220, the combiner controls the plurality of transmission channels to transmit respectively a plurality of sub-display signals obtained by dividing the complete display signal to be tile-displayed on the plurality of tile screen.

Taking the tiled system shown in FIG. 1 as an example, the combiner 120 controls its four transmission channels C1-C4 to transmit the four sub-display signals obtained by dividing the complete display signal, respectively. Herein, for convenience of explanation, it is assumed that the transmission channels C1-C4 transmit sub-display signals corresponding to the upper left portion, the upper right portion, the lower left portion and the lower right portion of the complete display signal, respectively. The transmission channels C1-C4 may be transmission channels such as HDMI, DVI, VGA and the like.

In step 230, for each of the transmission channels, the combiner determines which tile screen this transmission channel is to be connected to according to the feedback signal sent by the tile screen which has received the sub-display signal transmitted by this transmission channel.

Specifically, after the transmission channel has transmitted its corresponding sub-display signal, the tile screen that has received this sub-display signal may sent a feedback signal to the combiner through its wireless communication module, thus the combiner may determine which tile screen the transmission channel is connected to.

In step 240, the combiner regulates the sub-display signal transmitted in each of the transmission channels according to the tile screen connected with each of the transmission channels respectively and the position of each of the tile screens, so that the plurality of tile screens can be tiled to display the complete display signal.

Specifically, after determining the tile screen to which each of the transmission channels is connected to respectively and the position of each of the tile screens, the controller 120 may determine the proper correspondence of each of the transmission channels to each of the tile screens, by which the plurality of tile screens can be tiled to display the complete display signal. In response to the determined proper correspondence, one possible way is to reconnect each of the transmission channels and each of the tile screens according to the determined correspondence. While in this embodiment, it is not to carry out the reconnection, but to regulate the sub-display signal transmitted in each of the transmission channels so that, for each of the tile screens, a sub-display signal is transmitted in the transmission channel connected with this tile screen which is determined according to the proper correspondence and transmitted in the transmission channel corresponding to this tile screen.

The method for controlling the tiled display system according to the embodiment of the present disclosure has been described with reference to FIG. 2, and the specific processing of each step in the method can be seen in the detailed description about the functional implementation of the combiner 120. In addition, the above description is made taking the tiled display system shown in FIG. 1 as an example, but this is just an example, the control method according to the present embodiment may also be used for other tiled systems. For example, the control method according to the present embodiment can be applied to a case where a large-screen is tiled with a plurality of tile screens in other numbers; as another example, the control method according to the present embodiment is similarly used in the case where the number of the transmission channels of the combiner is greater than the number of the tile screens (for example, four), and in either case, any four transmission channels of the transmission channels are connected one-to-one to the four tile screens.

The basic principle of the present disclosure is described in connection with specific embodiments. However, it should be noted that, the advantages, superiorities, effects and the like are by way of example only, and the present disclosure is not limited to this. It is not to be understood that such advantages, superiorities, effects and the like are essential to the various embodiments of the present disclosure. In addition, the specific details disclosed above are for illustrative purposes only, and are not intended to be limiting, and the above details are not to limit the present disclosure to the extent that the specific details described above must be used for achieving the present disclosure.

The block diagrams of the parts, devices, apparatus, systems concerned in this disclosure are by way of example only, and are not intended to require or imply that the connection, arrangement, and configuration must be made in the manner shown in the block diagrams. As will be appreciated by those skilled in the art, such parts, devices, apparatus, systems may be connected, arranged, and configured in any manner. Words such as “comprise”, “include”, “have” and the like are open words, meaning “include, but not limited to” and may be used interchangeably therewith. As used herein, the words “or” and “and” mean the word “and/or”, and may be used interchangeably therewith, unless the context clearly indicates otherwise. The word “such as”, as used herein, means the phrase “such as but not limited to”, and can be used interchangeably therewith.

It is also to be noted that in the systems and methods of the present disclosure, various component or steps may be decomposed and/or recombined. These decomposition and/or recombination shall be considered as being equivalent to the present disclosure.

The above is only the specific embodiments of the present disclosure, but the protective scope of the present disclosure is not limited thereto, any variation or substitution that may be readily conceived by those skilled in this art within the technical scope revealed by the present disclosure are encompassed within the protective scope of the present disclosure. Therefore, the protective scope of the present disclosure should be in accord with the protective scope of the claims.

The application claims priority to the Chinese patent application No. 201610189280.4, filed Mar. 28, 2016, the entire disclosure of which is incorporated herein by reference as part of the present application.

What is claimed is:

1. A method for controlling a tiled display system, the tiled display system comprising a combiner and a plurality of tile screens, a plurality of transmission channels of the combiner being connected one-to-one to the plurality of tile screens, the control method comprising:
the combiner communicating with each of the tile screens respectively, and determining a position of each of the tile screens according to a strength of the signal received from each of the tile screens;
the combiner controlling the plurality of transmission channels to transmit respectively a plurality of sub-display signals that are obtained by dividing a complete display signal to be tile-displayed on the plurality of tile screens;
for each of transmission channels, the combiner determining which tile screen the transmission channel is to be connected to, according to a feedback signal sent by the tile screen which has received the sub-display signal transmitted by the transmission channel; and
the combiner regulating the sub-display signal transmitted in each of the transmission channels according to the tile screen connected with each of the transmission channels respectively and the position of each of the tile screens, so that the plurality of tile screens can be tiled to display the complete display signal.

2. The control method according to claim 1, further comprising: providing respectively a wireless communication module for the combiner and each of the tile screens,
wherein the combiner communicating with each of the tile screens respectively and determining the position of each of the tile screens according to the strength of the signals received from each of the tile screens further comprises:
the combiner communicating with each of the tile screens via wireless communication modules respectively;
the combiner determining a distance from each of the tile screens to the combiner according to the strength of the signal received from the wireless communication module of each of the tile screens; and
determining the position of each of the tile screens according to the distance.

3. The control method according to claim 2, wherein the feedback signal is sent by the wireless communication module of each of the tile screens.

4. The control method according to claim 2, wherein the wireless communication modules are Bluetooth communication modules.

5. The control method according to claim 1, wherein the plurality of transmission channels are connected one-to-one to the plurality of tile screens in any correspondence.

6. The control method according to claim 1, wherein the combiner regulating the sub-display signal transmitted in each of the transmission channels according to the tile screen connected with each of the transmission channels respectively and the position of each tile screen so that the plurality of tile screens can be tiled to display the complete display signal comprises:
the receiver determining correspondence of each of the transmission channels to each of the tile screens to allow that the plurality of tile screens can be tiled to display the complete display signal, according to the tile screens to which the transmission channels are connected respectively and the position of each of the tile screens; and
the combiner regulating the sub-display signal transmitted in each of the transmission channels so that, for each of the tile screens, the sub-display signal is transmitted in the transmission channel connected with the tile screen which is determined according to the correspondence and transmitted in the transmission channel corresponding to the tile screen.

7. The control method according to claim 1, wherein the transmission channels are HDMI channels.

8. A tiled display system comprising:
a plurality of tile screens to be tiled to display a complete display signal; and
a combiner, wherein the plurality of transmission channels of the combiner are connected one-to-one to the plurality of tile screens, the combiner is configured to determine the sub-display signals to be transmitted by the plurality of transmission channels respectively, so that the plurality of tile screen can be tiled to display a complete display signal, and the sub-display signals are obtained by dividing the complete display signal,
wherein the combiner and each of the tile screens are equipped with wireless communication modules respectively,
the combiner determines the sub-display signals to be transmitted by the plurality of transmission channels respectively as follows:
communicating with each of the tile screens via a respective wireless communication module, and determining a position of each of the tile screens according to a strength of the signal received from each of the tile screens;
controlling the plurality of transmission channels to transmit the plurality of sub-display signals respectively;
for each of the transmission channels, determining which tile screen the transmission channel is to be connected to, according to a feedback signal sent by the tile screen which has received the sub-display signal transmitted by the transmission channel; and
determining the sub-display signals transmitted by the plurality of transmission channels respectively according to the tile screens connected by the transmission channels respectively and the position of each of the tile screens.

9. The tiled display system according to claim 8, wherein the feedback signal is sent by the wireless communication module of each of the tile screens.

10. The tiled display system according to claim 8, wherein the wireless communication modules are Bluetooth communication modules.

11. The tiled display system according to claim 8, wherein communicating with each of the tile screens via the respective wireless communication module and determining the position of each of the tile screens according to the strength of the signal received from each of the tile screens further comprises:
the combiner determining a distance from each of the tile screens to the combiner according to the strength of the signal received from the wireless communication module of each of the tile screens; and determining the position of each of the tile screens according to the distance.

12. The tiled display system according to claim 8, wherein the plurality of transmission channels are connected one-to-one to the plurality of tile screens in any correspondence.

13. The tiled display system according to claim 8, wherein determining the sub-display signals transmitted by the plurality of transmission channels respectively according to the tile screens connected by the transmission channels respectively and the position of each of the tile screens comprises:
the receiver determining a correspondence of each of the transmission channels to each of the tile screens to allow that the plurality of tile screens to be tiled display the complete display signal, according to the tile screens to which the transmission channels are connected respectively and the position of each of the tile screens; and
the combiner regulating the sub-display signal transmitted in each of the transmission channels so that, for each tile screen, a sub-display signal is transmitted in the transmission channel connected with the tile screen which is determined according to the proper correspondence and transmitted in the transmission channel corresponding to the tile screen.

14. The tiled display system according to claim 8, wherein the transmission channels are HDMI channels.
